(19) United States
(12) Patent Application Publication
(10) Pub. No.: US 2026/0107159 A1
(43) Pub. Date: Apr. 16, 2026

(54) COMMUNICATION METHOD, USER EQUIPMENT, AND BASE STATION

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/419,665

(22) Filed: Dec. 15, 2025

Related U.S. Application Data
(63) Continuation of application No. PCT/JP2024/022148, filed on Jun. 19, 2024.

(30) Foreign Application Priority Data
Jun. 21, 2023 (JP) 2023-101316

(51) Int. Cl. H04W 24/02; H04W 4/06; H04W 84/04

(52) U.S. Cl. CPC H04W 24/02; H04W 4/06; H04W 84/042

(57) ABSTRACT

A communication method is performed by a user equipment in a mobile communication system for providing multicast/broadcast services (MBS), the communication method including the steps of: receiving, from a first public land mobile network (PLMN), configuration information for configuring radio environmental measurement of broadcast reception from a second PLMN different from the first PLMN; performing the radio environmental measurement of the broadcast reception based on the configuration information when performing the broadcast reception from the second PLMN; and transmitting, to the first PLMN, measurement information including a measurement result of the radio environmental measurement.

### RELATED APPLICATIONS

The present application is a continuation based on PCT Application No. PCT/JP2024/022148, filed on Jun. 19, 2024, which claims the benefit of Japanese Patent Application No. 2023-101316 filed on Jun. 21, 2023. The content of which is incorporated by reference herein in their entirety.

### TECHNICAL FIELD

The present disclosure relates to a communication method, a user equipment, and a base station that are used in a mobile communication system.

### BACKGROUND

The 3rd Generation Partnership Project (3GPP) (trade name, the same applies hereinafter) has defined technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR.

### CITATION LIST

### Non-Patent Literature

Non-Patent Document 1: 3GPP Technical Specification: TS 38.300 V17.4.0

### SUMMARY

In a first aspect, a communication method is performed by a user equipment in a mobile communication system for providing multicast/broadcast services (MBS), the communication method including the steps of: receiving, from a first public land mobile network (PLMN), configuration information for configuring radio environmental measurement of broadcast reception from a second PLMN different from the first PLMN; performing the radio environmental measurement of the broadcast reception based on the configuration information when performing the broadcast reception from the second PLMN; and transmitting, to the first PLMN, measurement information including a measurement result of the radio environmental measurement.

In a second aspect, a user equipment is used in a mobile communication system for providing multicast/broadcast services (MBS), the user equipment including: a receiver configured to receive, from a first public land mobile network (PLMN), configuration information for configuring radio environmental measurement of broadcast reception from a second PLMN different from the first PLMN; a controller configured to perform the radio environmental measurement of the broadcast reception based on the configuration information when performing the broadcast reception from the second PLMN; and a transmitter configured to transmit, to the first PLMN, measurement information including a measurement result of the radio environmental measurement.

In a third aspect, a base station belongs to a first public land mobile network (PLMN) in a mobile communication system for providing multicast/broadcast services (MBS), and the base station includes: transmitting, to a user equipment, configuration information for configuring radio environmental measurement of broadcast reception from a second PLMN different from the first PLMN; and a receiver configured to receive, from the user equipment, measurement information including a measurement result of the radio environmental measurement of the broadcast reception from the second PLMN.

### BRIEF DESCRIPTION OF THE DRAWINGS

FIG. 1 is a diagram illustrating a configuration example of a mobile communication system according to an embodiment.

FIG. 2 is a diagram illustrating a configuration example of a user equipment (UE) according to the embodiment.

FIG. 3 is a diagram illustrating a configuration example of a gNB (base station) according to the embodiment.

FIG. 4 is a diagram illustrating a configuration of a protocol stack of a radio interface of a user plane that handles data.

FIG. 5 is a diagram illustrating a configuration of a protocol stack of a radio interface of a control plane that handles signaling (control signal).

FIG. 6 is a diagram for describing an operation scenario for the mobile communication system according to the embodiment.

FIG. 7 is a diagram illustrating an operation example of the UE according to the embodiment.

FIG. 8 is a diagram illustrating an operation example of immediate MDT of the mobile communication system according to the embodiment.

FIG. 9 is a diagram illustrating an operation example of logged MDT of the mobile communication system according to the embodiment.

FIG. 10 is a diagram illustrating an operation example of a mobile communication system according to a variation.

### DESCRIPTION OF EMBODIMENTS

A user equipment may enable MBS broadcast reception from a different public land mobile network (PLMN) while existing in a certain PLMN. Such an MBS broadcast service may be a broadcast-only service such as general television broadcasts or radio broadcasts.

The different PLMN is considered to be able to easily perform network optimization related to the MBS by grasping a radio environment when the user equipment performs the broadcast reception from the different PLMN.

However, the user equipment may fail to perform uplink transmission to the different PLMN. Thus, the different PLMN cannot grasp the radio environment, causing difficulty of network optimization.

Accordingly, an object of the present disclosure is to facilitate network optimization related to the MBS.

A mobile communication system according to an embodiment will be described with reference to the drawings. In the description of the drawings, the same or similar parts are denoted by the same or similar reference signs.

### (1) System Configuration Example

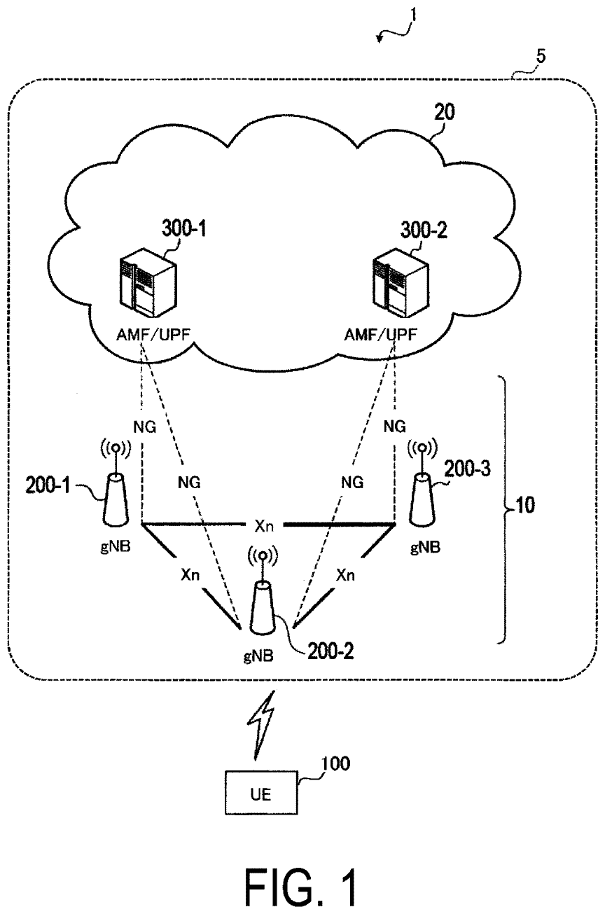

FIG. 1 is a diagram illustrating a configuration example of a mobile communication system 1 according to the embodiment. The mobile communication system 1 complies with the 5th Generation System (5GS) of the 3GPP standard. The description below takes the 5GS as an example, but a Long Term Evolution (LTE) system may be at least partially applied to the mobile communication system. Alternatively, a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a laptop PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface that is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term indicating a minimum unit of a wireless communication area. The “cell” is also used as a term indicating a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface that is an interface between a base station and the core network.

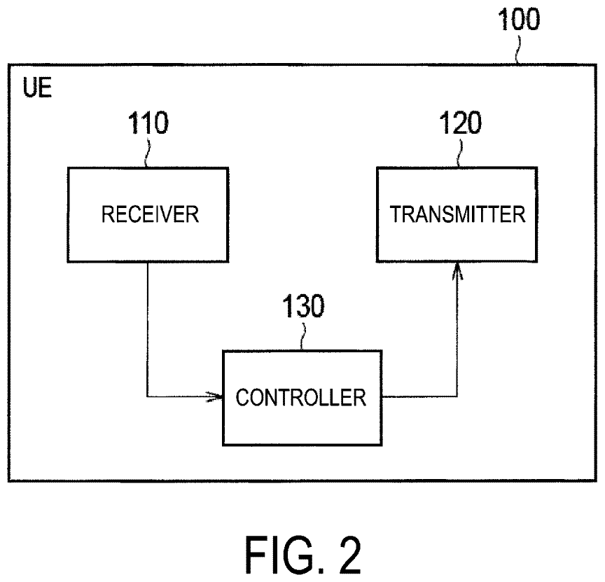

FIG. 2 is a diagram illustrating a configuration example of the user equipment (UE) 100 according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under the control of the controller 130. The receiver 110 includes an antenna and a reception device. The reception device converts a radio signal received by the antenna into a baseband signal (a reception signal) and outputs the resulting signal to the controller 130.

The transmitter 120 performs various types of transmission under the control of the controller 130. The transmitter 120 includes an antenna and a transmission device. The transmission device converts a baseband signal (transmission signal) output by the controller 130 into a radio signal and transmits the resulting signal from the antenna.

The controller 130 performs various controls and processes in the UE 100. Such processing includes processing of respective layers to be described below. The operations of the UE 100, which have been described above and will be described below, may be operations under the control of a controller 130. The controller 130 includes at least one processor and at least one memory. The memory stores programs that are executed by the processor and information that is used in processing by the processor. The processor may include a baseband processor and a Central Processing Unit (CPU). The baseband processor performs modulation/demodulation and encoding/decoding of a baseband signal. The CPU executes programs stored in the memory to perform various processes.

Note that the UE 100 may include a position estimator that acquires position information indication indicating a geographic position (latitude, longitude, altitude) of the UE 100 such as a Global Navigation Satellite System (GNSS) reception device.

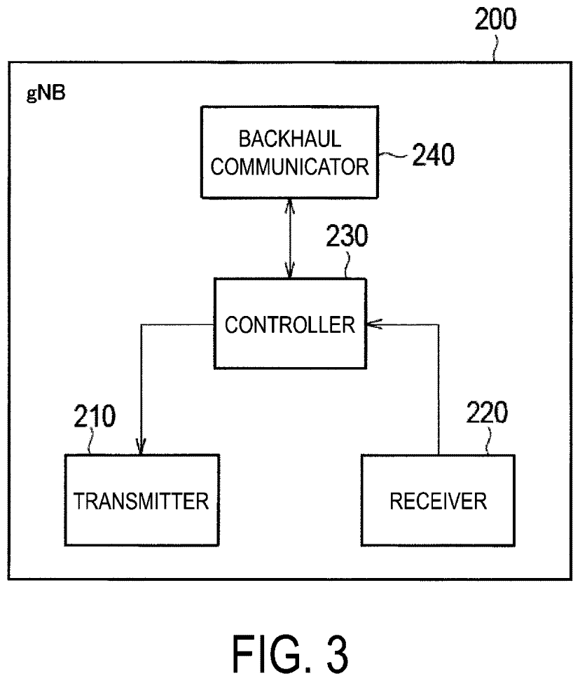

FIG. 3 is a diagram illustrating a configuration example of the gNB 200 (base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under the control of the controller 230. The transmitter 210 includes an antenna and a transmission device. The transmission device converts a baseband signal (a transmission signal) output by the controller 230 into a radio signal and transmits the resulting signal from the antenna.

The receiver 220 performs various types of reception under the control of the controller 230. The receiver 220 includes an antenna and a reception device. The reception device converts a radio signal received by the antenna into a baseband signal (a reception signal) and outputs the resulting signal to the controller 230.

The controller 230 performs various types of control and processing in the gNB 200. Such processing includes processing of respective layers to be described below. The operations of the gNB 200 described above and to be described below may be also performed under the control of the controller 230. The controller 230 includes at least one processor and at least one memory. The memory stores programs that are executed by the processor and information that is used in processing by the processor. The processor may include a baseband processor and a CPU. The baseband processor performs modulation/demodulation and encoding/decoding of a baseband signal. The CPU executes programs stored in the memory to perform various processes.

The backhaul communicator 240 is connected to a neighboring base station via an Xn interface that is an inter-base station interface. The backhaul communicator 240 is connected to the AMF/UPF 300 via an NG interface between a base station and the core network. Note that the gNB 200 may include a Central Unit (CU) and a Distributed Unit (DU) (that is, functions are divided), and both units may be connected via an F1 interface that is a fronthaul interface.

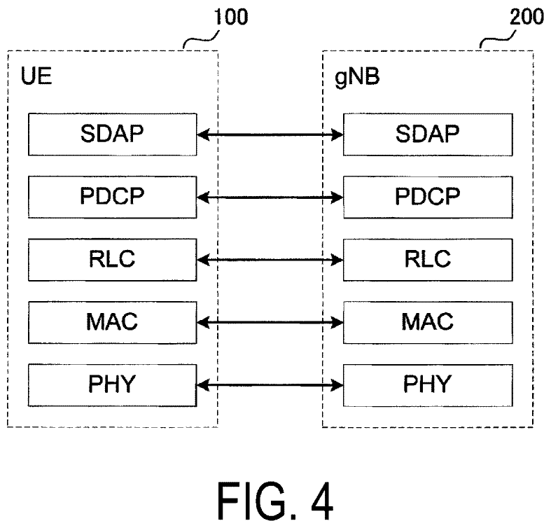

FIG. 4 is a diagram illustrating a configuration of a protocol stack of a radio interface of a user plane that handles data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 on a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with Cyclic Redundancy Code (CRC) parity bits scrambled by the RNTI.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer uses the functions of the MAC layer and the PHY layer to transmit data to the RLC layer on the receiving side. Data and control information are transmitted between the RLC layer of the UE 100 and the RLC layer of the gNB 200 through a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that when the RAN is connected to an EPC, the SDAP is not necessary.

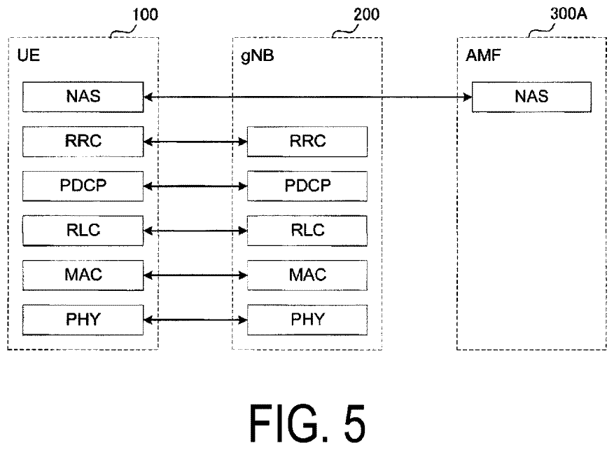

FIG. 5 is a diagram illustrating a configuration of a protocol stack of a radio interface of a control plane that handles signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to the establishment, re-establishment and release of radio bearers. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also simply referred to as “NAS”), that is located above the RRC layer, performs session management, mobility management, and the like. NAS signaling is transmitted between the NAS layer of the UE 100 and the NAS layer of an AMF 300A. Note that the UE 100 includes an application layer and the like in addition to the radio interface protocol. The layer below the NAS layer is referred to as an AS layer (also simply referred to as “AS”).

### (2) Overview of Mbs

The mobile communication system 1 can perform delivery with high resource efficiency by using the multicast/broadcast services (MBS).

### (2.1) MBS Broadcast

In the broadcast communication services (also referred to as “MBS broadcast”), the same service and the same specific content data are provided simultaneously to every UE 100 in a geographic area. That is, every UE 100 in the broadcast service area is permitted to receive the data. The broadcast communication services are delivered to the UE 100 by using a broadcast session that is a type of an MBS session. The UE 100 can receive the broadcast session in any state of the RRC idle state, the RRC inactive state, and the RRC connected state. Note that the MBS session can be identified by using an MBS session ID (for example, a Temporary Mobile Group Identity (TMGI)).

Point-to-Multipoint (PTM) delivery is applied to the broadcast communication service. In the PTM transmission, the gNB 200 delivers a single copy of an MBS packet to a set (group) of a plurality of UEs 100. For example, the gNB 200 uses a group-common PDCCH with a CRC scrambled by a Group RNTI (G-RNTI) that is a group-common RNTI to schedule a group-common PDSCH scrambled by the G-RNTI.

In the broadcast communication service, the UE 100 receives the broadcast session in the following procedure. First, the UE 100 receives SystemInformationBlockType20 (SIB20) from the gNB 200. SIB20 includes configuration of a Multicast Control CHannel (MCCH), which is a type of logical channel. Second, the UE 100 receives the MCCH from the gNB 200 based on SIB20. The MCCH includes PTM configuration. The PTM configuration transmits configuration for a Multicast Traffic CHannel (MTCH), which is a type of logical channel, and configuration for a Broadcast MRB, which is a Multicast Radio Bearer (MRB) for a broadcast session. The information transmitted by the MCCH may be referred to as MBS broadcast control information. Third, the UE 100 receives the MTCH based on the MCCH. The MTCH transmits a broadcast session (specifically, MBS data belonging to the broadcast session).

Note that the MCCH is a PTM downlink channel for transmitting MBS broadcast control information associated with one or more MTCHs from the network 10 to the UE 100. The MTCH is a PTM downlink channel for transmitting MBS data of a multicast session or a broadcast session from the network 10 to the UE 100.

### (2.2) MBS Multicast

In a multicast communication service (also referred to as “MBS multicast”), the same service and the same specific content data are simultaneously provided to a specific UE set. That is, not every UE 100 in a multicast service area is permitted to receive data. The multicast communication services are delivered to the UE 100 by using a multicast session that is a type of an MBS session.

The UE 100 can receive a multicast session only after joining the multicast session (session join). The joining of the multicast session may mean that the UE 100 is registered in a network 5 (the CN 20) as being capable of receiving the multicast session.

In the multicast communication service, in 3GPP Release 17, only the UE 100 in the RRC connected state can receive the multicast session. On the other hand, in 3GPP Release 18, the specification is planned to be extended so that the UE 100 in the RRC inactive state can also receive the multicast session.

### (3) Operation of Mobile Communication System

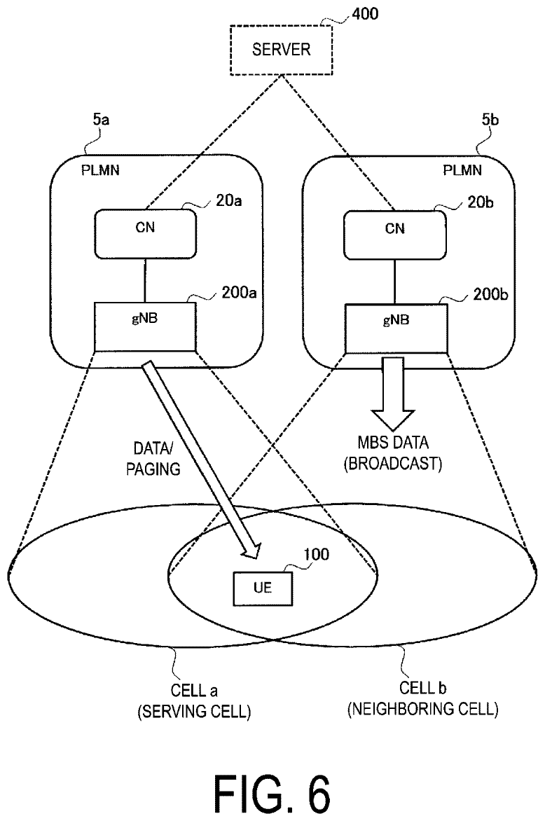

With reference to FIG. 6 to FIG. 9, an operation of the mobile communication system 1 according to the embodiment will be described.

### (3.1) Operation Scenario

FIG. 6 is a diagram for describing an operation scenario for the mobile communication system 1 according to the embodiment.

The UE 100 existing in an overlapping area of a cell a and a cell b communicates with the cell a. That is, the cell a is a serving cell of the UE 100, and the cell b is a neighboring cell of the serving cell. The UE 100 is in the RRC connected state, the RRC idle state, or the RRC inactive state in the cell a. The cell a is operated at a frequency (carrier frequency) a, and the cell b is operated at a frequency (carrier frequency) b. Such a relationship of frequencies is referred to as an inter-frequency.

A gNB 200a manages the cell a. A gNB 200b manages the cell b. The cell a (gNB 200a) belongs to a Public Land Mobile Network (PLMN) 5a as a first network. The cell b (gNB 200b) belongs to a PLMN 5b, which is a second network different from the first network. Such a relationship of PLMNs is referred to as an inter-PLMN.

The PLMN 5a includes the gNB 200a and a CN 20a. The PLMN 5b includes the gNB 200b and a CN 20b. In general, one operator is assigned one PLMN identifier. Each cell broadcasts an identifier of the PLMN to which the cell belongs.

When the UE 100 is in the RRC connected state in the cell a, the UE 100 performs data communication with the cell a (gNB 200a). Specifically, the UE 100 is assigned a C-RNTI from the gNB 200a as an identifier of RRC connection. The gNB 200a assigns a radio resource to the UE 100 by scheduling for the UE 100. When the UE 100 is in the RRC idle state or the RRC inactive state in the cell a, the UE 100 monitors paging from the cell a (gNB 200a). Specifically, the UE 100 monitors paging transmitted from the cell a (gNB 200a) at a paging reception timing (paging occasion) determined according to a parameter, such as an identifier of the UE 100.

In the embodiment, the cell b (gNB 200b) transmits MBS data belonging to a broadcast session in a PTM manner (that is, performs broadcast distribution by MBS broadcast).

The UE 100 may include a Subscriber Identity Module (SIM) corresponding to the PLMN 5a, and need not include a SIM corresponding to the PLMN 5b. For example, the cell b (gNB 200b) may provide the broadcast session in a Receive-Only Mode (ROM) and/or Free-To-Air (FTA). The ROM is a mode allowing the UE 100 to perform MBS reception even if the UE 100 does not include a Subscriber Identity Module (SIM) and/or does not have a service contract with an operator (PLMNs). The FTA is an application (service) for enabling the broadcasting of free broadcast content. The FTA may be one aspect of the ROM. The MBS broadcast that is provided in the FTA may be provided to be available to all users who are not mobile subscribers. In such a case, the UE 100 can receive the MBS broadcast from the PLMN 5b (also referred to as “broadcast reception”), but may be unable to perform unicast communication (for example, uplink transmission) with the PLMN 5b.

Alternatively, the UE 100 may include both a SIM corresponding to the PLMN 5a and a SIM corresponding to the PLMN 5b. Such a UE 100 is also referred to as a Multi-SIM UE or a Multi-Universal Subscriber Identity Module (USIM) UE. In such a case, the UE 100 can perform broadcast reception from the PLMN 5b and can also perform unicast communication (for example, uplink transmission) with the PLMN 5b.

In the following embodiment, a scenario in which the UE 100 includes a SIM corresponding to the PLMN 5a, does not include a SIM corresponding to the PLMN 5b, and cannot perform uplink transmission to the PLMN 5b is mainly assumed. The UE 100 receives the MBS broadcast that is provided in the ROM or FTA from the PLMN 5b. Such an MBS broadcast service may be a broadcast-only service such as general television broadcasts or radio broadcasts.

Here, the PLMN 5b grasps the radio environment when the UE 100 performs the broadcast reception from the PLMN 5b, enabling the PLMN 5b to easily optimize the network related to the MBS. However, in some cases, the UE 100 may be unable to perform uplink transmission to the PLMN 5b. Thus, the PLMN 5b cannot grasp the radio environment, and the PLMN 5b is difficult to optimize the network related to the MBS.

In the embodiment, the PLMN 5a provides configuration of radio environmental measurement for the PLMN 5b to the UE 100 based on, for example, a prior subscription with the PLMN 5b, and collects a measurement result of the radio environmental measurement from the UE 100. That is, the gNB 200a in the PLMN 5a configures the UE 100 to collect and report area quality information of the PLMN 5b. The PLMN 5a then provides the collected measurement information to the PLMN 5b. This enables the PLMN 5b to easily optimize the network related to the MBS.

In the embodiment, a server 400 may be provided that temporarily holds the measurement information when the measurement information is provided from the PLMN 5a to the PLMN 5b. Alternatively, the measurement information may be directly provided from the PLMN 5a to the PLMN 5b without the server 400.

### (3.2) Operation Example of UE

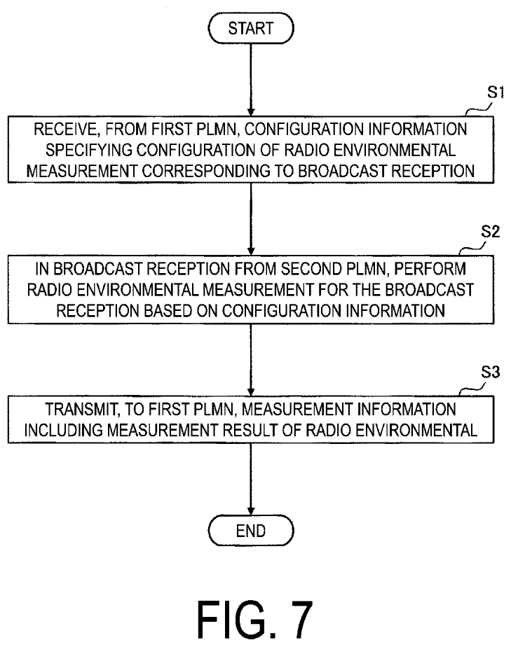

FIG. 7 is a diagram illustrating an operation example of the UE 100 according to the embodiment.

In step S1, the UE 100 receives, from the PLMN 5a (first PLMN), configuration information for configuring radio environmental measurement of broadcast reception from the PLMN 5b (second PLMN) different from the PLMN 5a.

Prior to step S1, the UE 100 may transmit, to the gNB 200a belonging to the PLMN 5a, interest information indicating that the UE 100 is interested in receiving a broadcast from the PLMN 5b. The gNB 200a belonging to the PLMN 5a may transmit the configuration information to the UE 100 based on the interest information.

The configuration information of step S1 may include session information (a session identifier) indicating a broadcast session provided by the PLMN 5b and/or PLMN information (a PLMN identifier) indicating the PLMN 5b. The configuration information of step S1 may include a TMGI combining a PLMN identifier and a session identifier.

In step S2, when the UE 100 existing in the PLMN 5a performs broadcast reception from the PLMN 5b, the UE 100 performs radio environmental measurement for the broadcast reception based on the configuration information of step S1.

The radio environmental measurement of step S2 may be performed by the UE 100 in the RRC idle state or the RRC inactive state in the PLMN 5a. In this case, the UE 100 in the RRC idle state or the RRC inactive state may hold the measurement information obtained by performing the radio environmental measurement as a measurement log, and transmit the measurement log to the PLMN 5a when the UE 100 is connected to the PLMN 5a later. Such a measurement and reporting method is also referred to as logged Minimization of Drive Test (MDT).

Alternatively, the UE 100 in the RRC connected state in the PLMN 5a may perform the radio environmental measurement of step S2. In this case, the UE 100 in the RRC connected state may immediately transmit, to the PLMN 5a (gNB 200a), the measurement information obtained by performing the radio environmental measurement. Such a measurement and reporting method is also referred to as immediate MDT.

In step S3, the UE 100 in the RRC connected state in the PLMN 5a transmits, to the PLMN 5a, the measurement information (that may be a measurement log) including a measurement result of the radio environmental measurement in step S2.

Note that in step S2, the UE 100 that exists in the PLMN 5a and that performs the broadcast reception from the PLMN 5b may measure at least one of communication state information indicating a communication load and/or a communication capacity with the PLMN 5a or communication state information indicating a communication load and/or a communication capacity with the PLMN 5b. In step S3, the UE 100 may transmit the measurement information further including the communication state information to the PLMN 5a.

The measurement information of step S3 may further include position information indicating a geographic position of the UE 100 when the radio environmental measurement of step S2 is performed and/or time information indicating a timing at which the radio environmental measurement of step S2 is performed.

### (3.3) Operation Example of Immediate MDT

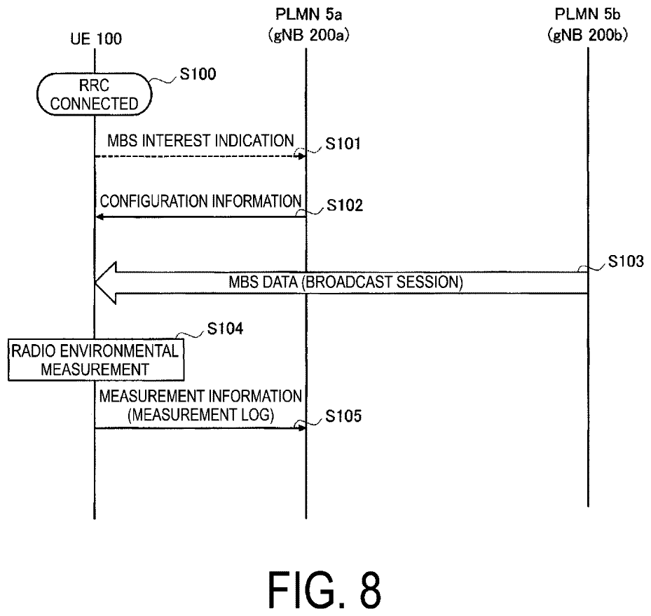

FIG. 8 is a diagram illustrating an operation example of immediate MDT of the mobile communication system 1 according to the embodiment.

In step S100, the UE 100 is in the RRC connected state in the PLMN 5a. To be specific, the UE 100 has established RRC connection with the gNB 200a in the PLMN 5a.

In step S101, the UE 100 may transmit an MBS Interest Indication message to the gNB 200a of the PLMN 5a, where the MBS Interest Indication message includes information indicating interest in MBS broadcast reception from the PLMN 5b. The information may include session information (a session identifier) indicating a broadcast session that the UE 100 is interested in receiving and/or PLMN information (a PLMN identifier) indicating the PLMN 5b that provides a broadcast session that the UE 100 is interested in receiving. The information may be a TMGI obtained by combining a PLMN identifier and a session identifier. The information may include information indicating a frequency (MBS frequency) for providing a broadcast session that the UE 100 is interested in receiving. The gNB 200a may recognize that the UE 100 is interested in broadcast reception based on the MBS interest indication message from the UE 100.

In step S102, the gNB 200a in the PLMN 5a transmits configuration information to UE 100, thereby providing configuration related to measurement and reporting related to broadcast reception from the PLMN 5b. The UE 100 receives the configuration information from the gNB 200a in the PLMN 5a. The configuration information includes at least one type of information (a configuration parameter) of the following 1) to 5).

### 1) Configuration of Measurement Target:

A measurement target may be at least one selected from the group consisting of a session identifier, a PLMN identifier, and a TMGI. The measurement target may be an indicator indicating that measurement and reporting of a different PLMN are performed. The UE 100 may perform measurement only when the PLMN and/or the broadcast session specified as the measurement target is performing broadcast reception.

### 2) Configuration of Measurement Content:

A measurement content may be, for example, at least one selected from the group consisting of a Reference Signal Received Power (RSRP), a Reference Signal Received Quality (RSRQ), and a Signal-to-Interference-plus-Noise Ratio (SINR) of the PLMN 5b. The measurement content may be at least one selected from the group consisting of a Bit Error Rate (BER), a BLock Error Rate (BLER), and a Packet Error Rate (PER) of MBS data received by the UE 100 from the PLMN 5b.

### 3) Configuration of Communication State Information to Be Measured:

The communication state information is information about a state of simultaneous communication (shared processing) with two PLMNs 5 in the UE 100. The communication state information makes it easy to specify the cause of quality degradation of the MBS reception in the UE 100.

The communication state information to be measured by the UE 100 may be a communication load and/or a processing load with the PLMN 5a. The communication state information to be measured by the UE 100 may be a communication capacity and/or a processing capability remaining for the MBS broadcast reception from the PLMN 5b.

Here, when a gap period, that is, a period in which communication with the PLMN 5a is interrupted, is provided in a time-division manner for the MBS broadcast reception from the PLMN 5b, the communication state information may be a time width and/or a cycle of the gap period. The communication state information may be a time width and/or a frequency during unicast scheduling of the PLMN 5a. The communication state information may be a time width and/or a frequency that is available (not assigned) in scheduling for reception from the PLMN 5b. The communication state information may be whether unicast scheduling of the PLMN 5a collides with an MBS broadcast reception timing from the PLMN 5b, or a frequency of collision. The communication state information may be a processing load and/or a capacity (a processor load, a memory load, or the like) that is being used in unicast communication in the PLMN 5a during the MBS broadcast reception from the PLMN 5b. The communication state information may be a processing load and/or a capacity that is being used for the MBS broadcast reception from the PLMN 5b. The communication state information may be a total processing load that is being used for both the unicast communication with the PLMN 5a and the MBS broadcast reception from the PLMN 5b.

### 4) Configuration of Measurement Event:

A measurement event may be an event when measurement is performed once by an event trigger, or an event when periodic measurement is started by an event trigger. These events may be an event in which the reception quality (RSRP and/or BER) has become worse than a threshold value, and the configuration may include the threshold value. These events may be an event in which the reception processing load (CPU load or the like) has become worse than a threshold value, and the configuration may include the threshold value.

The measurement event may be a measurement cycle when periodic measurement is performed.

### 5) Configuration of Reporting Condition:

A reporting condition may be a condition that reporting is performed immediately (as needed) after measurement. When the UE 100 transmits a Measurement Report message including the measurement information to the PLMN 5a, the reporting condition may be information for configuring a transmission condition of the Measurement Report message.

In step S103, the UE 100 in the RRC connected state in the PLMN 5a starts receiving an MBS broadcast session from the PLMN 5b.

In step S104, the UE 100 in the RRC connected state in the PLMN 5a performs radio environmental measurement related to the broadcast reception from the PLMN 5b in accordance with the configuration information of step S102. For example, the UE 100 measures the configured measurement content for the configured measurement target based on the configured measurement event. The UE 100 may perform measurement for the configured communication state information. The UE 100 may acquire position information indicating a geographic position of the UE 100 at the time of the measurement.

In step S105, the UE 100 transmits measurement information including the measurement result of step S104 to the gNB 200a of the PLMN 5a. The UE 100 may transmit a Measurement Report message that is one type of RRC message and that includes the measurement information. The measurement information may include position information indicating a geographic position of the UE 100 at the time of the measurement. The measurement information may include an ID (login ID or user ID) assigned to the UE 100 by the PLMN 5b and/or an International Mobile Subscription Identity (IMSI) of the UE 100. The measurement information may include cause information related to deterioration of each measurement content (for example, BLER). The cause information may be the communication state information or may be information indicating a simplified cause classification. The cause classification may be any of degradation in radio reception quality (for example, degradation in BLER), configuration failure (for example, mismatch between gap configuration and MBS reception occasion), and degradation in processing load of the UE 100 (for example, an increase in processing load related to unicast communication and/or a decrease in processing capacity related to MBS reception).

The PLMN 5a may provide the measurement information received from the UE 100 in step S105 to the PLMN 5b, for example, via a server. The PLMN 5b may use the measurement information to optimize the network in the PLMN 5b, for example, to change various configuration parameters in the PLMN 5b. The PLMN 5a may use at least a part of the measurement information to optimize the network in the PLMN 5a, for example, to change various configuration parameters in the PLMN 5a.

### (3.4) Operation Example of Logged MDT

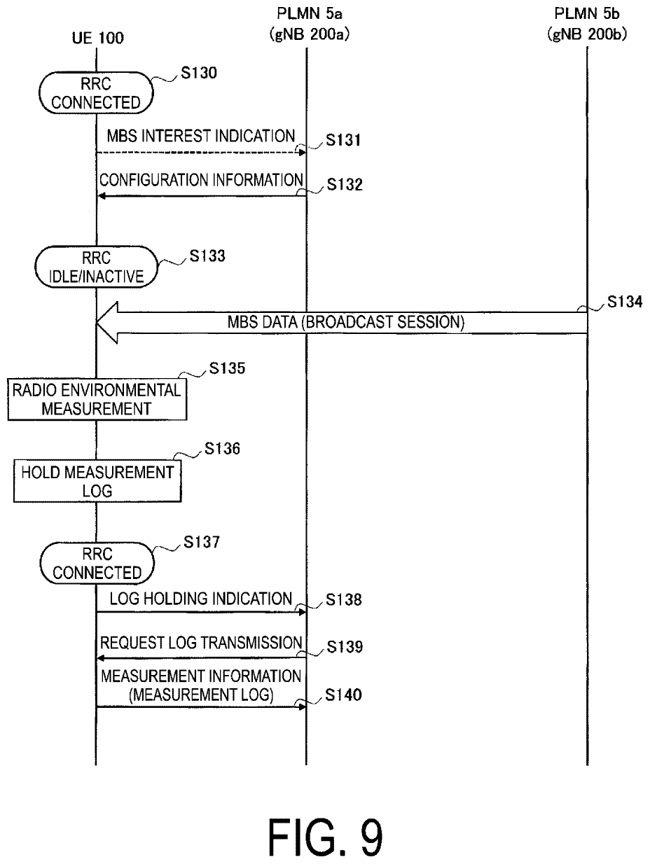

FIG. 9 is a diagram illustrating an operation example of logged MDT of the mobile communication system 1 according to the embodiment.

In step S130, the UE 100 is in the RRC connected state in the PLMN 5a. To be specific, the UE 100 has established RRC connection with the gNB 200a in the PLMN 5a.

In step S131, the UE 100 may transmit an MBS Interest Indication message to the gNB 200a of the PLMN 5a, where the MBS Interest Indication message includes information indicating interest in MBS broadcast reception from the PLMN 5b. Details of the MBS interest indication are the same as and/or similar to those of the operation of the immediate MDT described above. The gNB 200a may recognize that the UE 100 is interested in broadcast reception based on the MBS interest indication message from the UE 100.

In step S132, the gNB 200a in the PLMN 5a transmits configuration information to the UE 100, thereby providing configuration of measurement and reporting related to the broadcast reception from the PLMN 5b. The UE 100 receives the configuration information from the gNB 200a in the PLMN 5a. The configuration information includes at least one information (configuration parameter) selected from the group consisting of 1) to 5) described above. However, in the logged MDT, the information (configuration parameters) of 4) and 5) described above may include the following contents.

### 4) Configuration of Logging Event:

Logging means holding measurement information as a measurement log. A logging event may be an event when logging is performed once by an event trigger, or an event when periodic logging is started by an event trigger. These events may be an event in which the reception quality (RSRP and/or BER) has become worse than a threshold value, and the configuration may include the threshold value. These events may be an event in which the reception processing load (CPU load or the like) has become worse than a threshold value, and the configuration may include the threshold value.

The logging event may be a logging cycle when periodic logging is performed.

### 5) Configuration of Reporting Condition:

The configuration of a reporting condition includes information for configuring a condition for transmitting the measurement log. The condition may include at least one selected from the group consisting of the following a) to c).

### a) Time:

For example, a condition that the held measurement log is reported at a certain time (for example, 00:00) every day is configured.

### b) Cycle:

For example, a condition that the held measurement log is reported every predetermined time period (for example, one hour) is configured. Note that a condition may be configured that the held measurement log is reported every time a predetermined time period (for example, one hour) elapses while the MBS broadcast reception from the PLMN 5b is continually performed.

### c) Log Data Size:

For example, a condition is configured that the held log is reported each time the total size of the held measurement log exceeds a predetermined size (for example, 1 MB).

Note that the reporting condition may be a condition for transmitting a log holding indication indicating that the measurement log is held.

In step S133, the UE 100 transitions from the RRC connected state to the RRC idle state or the RRC inactive state in the PLMN 5a. Note that the configuration information of step S132 may be held in the UE 100 until the UE 100 transitions to the RRC idle state or the RRC inactive state, and may be applied when the UE 100 transitions to the RRC idle state or the RRC inactive state.

In step S134, the UE 100 in the RRC idle state or the RRC inactive state in the PLMN 5a starts receiving an MBS broadcast session of the PLMN 5b.

In step S135, the UE 100 in the RRC idle state or the RRC inactive state in the PLMN 5a performs radio environmental measurement related to the broadcast reception from the PLMN 5b in accordance with the configuration information in step S132. For example, the UE 100 performs measurement and logging of the configured measurement content related to the configured measurement target based on the configured logging event. The UE 100 may perform measurement for the configured communication state information. The UE 100 may acquire position information indicating a geographic position of the UE 100 at the time of the measurement and time information indicating a measurement timing.

In step S136, the UE 100 in the RRC idle state or the RRC inactive state in the PLMN 5a holds the measurement information including the measurement result of step S135 as the measurement log.

Note that while the UE 100 is in the RRC idle state or the RRC inactive state, the UE 100 may repeatedly perform the operation of step S134 to step S136.

In step S137, the UE 100 transitions from the RRC idle state or the RRC inactive state to the RRC connected state in the PLMN 5a.

In step S138, the UE 100 in the RRC connected state in the PLMN 5a transmits, to the gNB 200a in the PLMN 5a, a log holding indication (Availability Indication) indicating that the UE 100 holds the measurement log. The log holding indication may be an information element different from a log holding indication indicating that a measurement log in general logged MDT is held.

In step S139, the gNB 200a in the PLMN 5a transmits, to the UE 100, a log transmission request (UE Information Request) for requesting transmission of the measurement log.

In step S140, the UE 100 in the RRC connected state in the PLMN 5a transmits a message (UE Information Response message) including the held measurement log to the gNB 200a in the PLMN 5a in response to reception of the log transmission request. The message may include the same content as that of a Measurement Report message of step S105 described above.

The PLMN 5a may provide, to the PLMN 5b, the measurement information (measurement log) received from the UE 100 in step S140, for example, via a server. The PLMN 5b may use the measurement information to optimize the network in the PLMN 5b, for example, to change various configuration parameters in the PLMN 5b. The PLMN 5a may use at least a part of the measurement information to optimize the network in the PLMN 5a, for example, to change various configuration parameters in the PLMN 5a.

### (4) Variation of Operation of Mobile Communication System

A variation of the operation of the mobile communication system 1 as described above will be described. In the above-described embodiment, the PLMN 5a may receive, from the UE 100, the measurement information of the PLMN 5b by the UE 100, and decipher the received measurement information. However, from the perspective of the PLMN 5b, the fact that the PLMN 5a can decipher the measurement information of the PLMN 5b may cause a security problem.

In this variation, the UE 100 encrypts the measurement information (measurement log) such that the measurement information can be decrypted by the PLMN 5b but cannot be decrypted by the PLMN 5a. Then, the UE 100 transmits the encrypted measurement information to the PLMN 5a. Here, the UE 100 may transmit, to the PLMN 5a, a message (Measurement Report message or UE Information Response message) including the encrypted measurement information in a container addressed to the PLMN 5b. The container configures a part of the message and stores the measurement information for the PLMN 5b.

Note that this variation is applicable to both the immediate MDT and the logged MDT described above. An operation of the mobile communication system 1 according to this variation will be described below, focusing on differences from the embodiment described above.

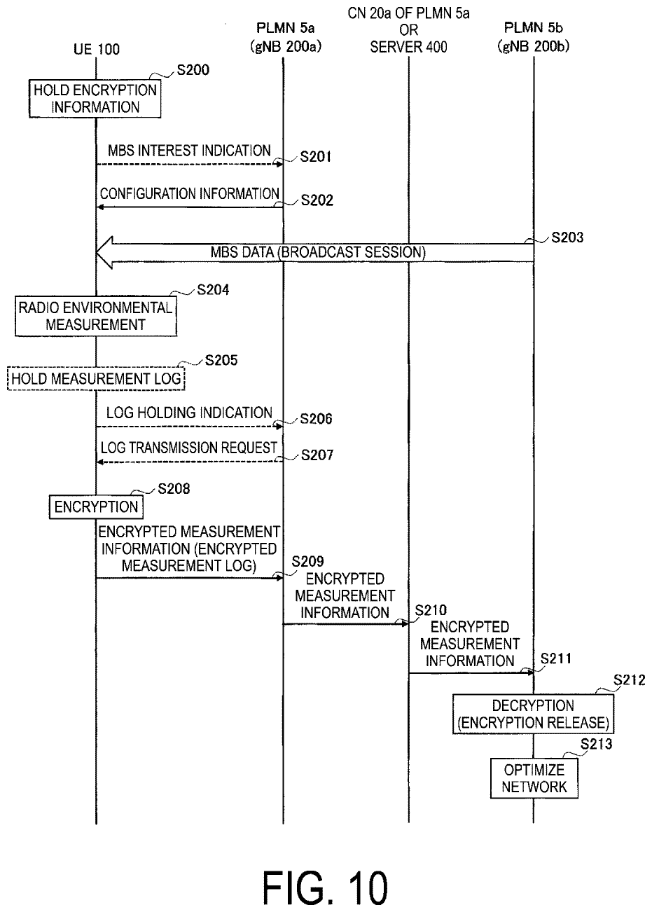

FIG. 10 is a diagram illustrating an operation example of the mobile communication system 1 according to this variation.

In step S200, an upper layer (for example, an application layer or a NAS layer) of the UE 100 holds encryption information that is used for encryption. The encryption information includes information of an encryption scheme and an encryption key. The encryption information is information that the PLMN 5 a does not know but the PLMN 5b knows.

Here, as a method for the UE 100 to hold the encryption information, the following methods 1 to 3 are exemplified.

### Method 1:

When the user establishes a subscription with the PLMN 5b, an encryption scheme and an encryption key are assigned and stored in the UE 100.

### Method 2:

The encryption scheme and the encryption key are written in the USIM (or ROM) in the UE 100 in advance at the time of shipment from a factory and/or at the time of subscription establishment.

### Method 3:

The encryption scheme and the encryption key are provided by a viewing application (for example, a TV viewing application) installed in the UE 100.

The operation from step S201 to step S207 is the same as and/or similar to that in the embodiment described above.

In step S208, the UE 100 encrypts the measurement information (measurement log) by using the encryption information held in step S200. In the UE 100, the encryption information may be provided from an upper layer to a lower layer (a layer that performs encryption).

In step S209, the UE 100 stores the measurement information (measurement log) encrypted in step S208 in a container in a Measurement Report message or a container in a UE Information Response message, and transmits the message to the gNB 200a of the PLMN 5a.

In step S210, the gNB 200a in the PLMN 5a may retrieve the encrypted data from the container in the message of step S209 and transmit the extracted encrypted data to the CN 20a in the PLMN 5a or the server 400. The gNB 200a of the PLMN 5a may perform the transmission to the gNB 200b or the CN 20b of the PLMN 5b when a direct interface with the PLMN 5b is present.

In step S211, the CN 20a of the PLMN 5a or the server 400 transmits the encrypted data to the PLMN 5b.

In step S212, the PLMN 5b decrypts (releases encryption) the encrypted data by using the encryption information shared with the UE 100, and acquires the measurement information (measurement log).

In the step S213, the PLMN 5b optimizes the network by using the information acquired in the step S212, for example, the PLMN 5b optimizes the area of the PLMN 5b.

### (5) Other Embodiments

In the above-described embodiment, a scenario in which the UE 100 existing in the PLMN 5a performs the MBS broadcast reception from the PLMN 5b is assumed. However, a scenario in which the UE 100 existing in the PLMN 5a performs MBS multicast reception from the PLMN 5b may be assumed. Thus, the broadcast reception in the operation according to the above-described embodiment may be read as multicast reception.

The operation flows described above can be separately and independently implemented, and also be implemented in combination of two or more of the operation flows. For example, one or some steps of one operation flow may be added to another operation flow or one or some steps of one operation flow may be replaced with one or some steps of another operation flow. In each flow, all steps need not be necessarily performed, and only one or some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a relay device that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded on a computer-readable medium. The computer-readable medium allows the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing that is performed by the UE 100 or the gNB 200 may be integrated, and at least a part of the UE 100 or the gNB 200 may be implemented as a semiconductor integrated circuit (chipset, System on a Chip (SoC)).

The functions provided by the UE 100 or the gNB 200 (network node) may be implemented in circuitry or processing circuitry including a general-purpose processor, a special-purpose processor, an integrated circuit, Application Specific Integrated Circuits (ASICs), a Central Processing Unit (CPU), a conventional circuit, and/or combinations thereof which are programmed to perform the described functionality. The processor includes a transistor and other circuits, and is considered as circuitry or processing circuitry. The processor may be a programmed processor that executes a program stored in a memory. In the present description, circuitry, units, means are hardware programmed to achieve or hardware to execute the described functions. The hardware may be any hardware disclosed in the present description, any hardware programmed to achieve or known to execute the described functions. When the hardware is a processor considered to be a type of circuitry, the circuitry, means, or units are a combination of hardware and software used to configure the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various types of design variation can be made without departing from the gist of the present disclosure.

### (6) Supplementary Notes

Features relating to the embodiments described above will be described below as supplements.

### Supplementary Note 1

A communication method to be performed by a user equipment in a mobile communication system for providing multicast/broadcast services (MBS), the communication method including the steps of:
receiving, from a first public land mobile network (PLMN), configuration information for configuring radio environmental measurement of broadcast reception from a second PLMN different from the first PLMN;
performing the radio environmental measurement of the broadcast reception based on the configuration information when performing the broadcast reception from the second PLMN; and
transmitting, to the first PLMN, measurement information including a measurement result of the radio environmental measurement.

### Supplementary Note 2

The communication method according to Supplementary Note 1, further including the steps of: transmitting, to a network node belonging to the first PLMN, interest information indicating interest in the broadcast reception from the second PLMN; and transmitting, by the network node to the user equipment, the configuration information based on the interest information.

### Supplementary Note 3

The communication method according to Supplementary Note 1 or 2, wherein the configuration information includes session information indicating a broadcast session provided by the second PLMN and/or PLMN information indicating the second PLMN.

### Supplementary Note 4

The communication method according to any one of Supplementary Notes 1 to 3, further including; holding, by the user equipment in a radio resource control (RRC) idle state or an RRC inactive state, the measurement information obtained by performing the radio environmental measurement as a measurement log,
wherein the configuration information includes information for configuring a trigger condition related to transmission of the measurement log or a notification indicating holding of the measurement log to the second PLMN.

### Supplementary Note 5

The communication method according to any one of Supplementary Notes 1 to 4, wherein the performing of the radio environmental measurement includes measuring, by the user equipment existing in the first PLMN and performing the broadcast reception from the second PLMN, at least one of communication state information indicating a communication load and/or a communication capacity with the first PLMN or communication state information indicating a communication load and/or a communication capacity with the second PLMN, and the transmitting of the measurement information includes transmitting, to the first PLMN, the measurement information further including the communication state information.

### Supplementary Note 6

The communication method according to Supplementary Note 5, wherein the configuration information includes information for configuring the measuring of the communication state information.

### Supplementary Note 7

The communication method according to any one of Supplementary Notes 1 to 6, wherein the measurement information further includes position information indicating a geographic position of the user equipment when the radio environmental measurement is performed and/or time information indicating a timing at which the radio environmental measurement is performed.

### Supplementary Note 8

The communication method according to any one of Supplementary Notes 1 to 7, further including:
performing encryption on the measurement information, the encryption being decipherable by the second PLMN and being indecipherable by the first PLMN,
wherein the transmitting of the measurement information includes transmitting the encrypted measurement information to the first PLMN.

### Supplementary Note 9

The communication method according to Supplementary Note 8, wherein
the transmitting of the measurement information includes transmitting, to the first PLMN, a message including the encrypted measurement information in a container addressed to the second PLMN.

### Supplementary Note 10

A user equipment to be used in a mobile communication system for providing multicast/broadcast services (MBS), the user equipment including:
a receiver configured to receive, from a first public land mobile network (PLMN), configuration information for configuring radio environmental measurement of broadcast reception from a second PLMN different from the first PLMN;
a controller configured to perform the radio environmental measurement of the broadcast reception based on the configuration information when performing the broadcast reception from the second PLMN; and
a transmitter configured to transmit, to the first PLMN, measurement information including a measurement result of the radio environmental measurement.

### Supplementary Note 11

A network node belonging to a first public land mobile network (PLMN) in a mobile communication system for providing multicast/broadcast services (MBS), the network node including:
transmitting, to a user equipment, configuration information for configuring radio environmental measurement of broadcast reception from a second PLMN different from the first PLMN; and
a receiver configured to receive, from the user equipment, measurement information including a measurement result of the radio environmental measurement of the broadcast reception from the second PLMN.

### REFERENCE SIGNS

1: Mobile communication system
5: Network
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method to be performed by a user equipment in a mobile communication system for providing multicast/broadcast services (MBS), the communication method comprising:
receiving, from a first public land mobile network (PLMN), configuration information for configuring radio environmental measurement of broadcast reception from a second PLMN different from the first PLMN;
performing the radio environmental measurement of the broadcast reception, based on the configuration information when performing the broadcast reception from the second PLMN; and
transmitting, to the first PLMN, measurement information comprising a measurement result of the radio environmental measurement.

2. The communication method according to claim 1, further comprising:
transmitting, to a network node belonging to the first PLMN, interest information indicating interest in the broadcast reception from the second PLMN; and
transmitting, by the network node to the user equipment, the configuration information based on the interest information.

3. The communication method according to claim 1, wherein
the configuration information comprises session information indicating a broadcast session provided by the second PLMN and/or PLMN information indicating the second PLMN.

4. The communication method according to claim 1, further comprising:
holding, by the user equipment in a radio resource control (RRC) idle state or an RRC inactive state, the measurement information obtained by performing the radio environmental measurement as a measurement log,
wherein the configuration information comprises information for configuring a trigger condition related to transmission of the measurement log or a notification indicating holding of the measurement log to the second PLMN.

5. The communication method according to claim 1, wherein
the performing of the radio environmental measurement comprises measuring, by the user equipment existing in the first PLMN and performing the broadcast reception from the second PLMN, at least one of communication state information indicating a communication load and/or a communication capacity with the first PLMN or communication state information indicating a communication load and/or a communication capacity with the second PLMN, and
the transmitting of the measurement information comprises transmitting, to the first PLMN, the measurement information further comprising the communication state information.

6. The communication method according to claim 5, wherein
the configuration information comprises information for configuring the measuring of the communication state information.

7. The communication method according to claim 1, wherein
the measurement information further comprises position information indicating a geographic position of the user equipment when the radio environmental measurement is performed and/or time information indicating a timing at which the radio environmental measurement is performed.

8. The communication method according to claim 1, further comprising:
performing encryption on the measurement information, the encryption being decipherable by the second PLMN and being indecipherable by the first PLMN,
wherein the transmitting of the measurement information comprises transmitting the encrypted measurement information to the first PLMN.

9. The communication method according to claim 8, wherein
the transmitting of the measurement information comprises transmitting, to the first PLMN, a message comprising the encrypted measurement information in a container addressed to the second PLMN.

10. A user equipment to be used in a mobile communication system for providing multicast/broadcast services (MBS), the user equipment comprising:
a receiver configured to receive, from a first public land mobile network (PLMN), configuration information for configuring radio environmental measurement of broadcast reception from a second PLMN different from the first PLMN;
a controller configured to perform the radio environmental measurement of the broadcast reception, based on the configuration information when performing the broadcast reception from the second PLMN; and
a transmitter configured to transmit, to the first PLMN, measurement information comprising a measurement result of the radio environmental measurement.

11. A network node belonging to a first public land mobile network (PLMN) in a mobile communication system for providing multicast/broadcast services (MBS), the network node comprising:
a transmitter configured to transmit, to a user equipment, configuration information for configuring radio environmental measurement of broadcast reception from a second PLMN different from the first PLMN; and
a receiver configured to receive, from the user equipment, measurement information comprising a measurement result of the radio environmental measurement of the broadcast reception from the second PLMN.
